(19) United States
(12) Patent Application Publication
(10) Pub. No.: US 2025/0036713 A1
(43) Pub. Date: Jan. 30, 2025

(54) INFERENCE APPARATUS

(71) Applicant: Preferred Networks, Inc., Tokyo (JP)

(72) Inventor: Iori KURATA, Tokyo (JP)

(73) Assignee: Preferred Networks, Inc., Tokyo (JP)

(21) Appl. No.: 18/783,815

(22) Filed: Jul. 25, 2024

(30) Foreign Application Priority Data
Jul. 28, 2023 (JP) 2023-123739

(51) Int. Cl. G06F 17/11

(52) U.S. Cl. CPC G06F 17/11

(57) ABSTRACT

An inference apparatus according to an embodiment includes at least one memory and at least one processor. The at least one processor calculates a Hamiltonian as an initial value regarding a substance based on a neural network algorithm, and calculates a non-equilibrium Green's function regarding the substance based on the Hamiltonian as the initial value.

### CROSS-REFERENCE TO RELATED APPLICATIONS

This application is based upon and claims the benefit of priority from Japanese Patent Application No. 2023-123739, filed on Jul. 28, 2023; the entire contents of which are incorporated herein by reference.

### BACKGROUND OF THE INVENTION

### 1. Field of the Invention

An embodiment of the present disclosure relates to an inference apparatus.

### 2. Description of the Related Art

For example, in the case of obtaining a non-equilibrium Green's function of a physical system including multibody atomic nuclei and electrons, a Hamiltonian of the physical system is needed. However, such a Hamiltonian of a physical system cannot be obtained by strict calculation, and thus is typically obtained by approximate calculation.

For example, a highly accurate Hamiltonian can be calculated by a method (DFT method) using a Density Functional Theory (DFT) model as an approximate calculation method. In addition, for example, the Hamiltonian can be calculated with a low calculation load by a method (semi-empirical method) using a semi-empirical model as an approximate calculation method.

However, obtaining the Hamiltonian and the non-equilibrium Green's function of the physical system by using the DFT method would need a high calculation load. On the other hand, obtaining the Hamiltonian and the non-equilibrium Green's function of the physical system by using a semi-empirical method can reduce the calculation load, but might not be able to achieve sufficient accuracy.

### SUMMARY OF THE INVENTION

### BRIEF DESCRIPTION OF THE DRAWINGS

FIG. 1 is a block diagram illustrating an example of a hardware configuration of an inference apparatus according to an embodiment;

FIG. 2 is a diagram illustrating an example of functional blocks in a processor according to the embodiment; and

FIG. 3 is a flowchart illustrating an example of a flow of inference processing executed by the inference apparatus according to the embodiment.

### DETAILED DESCRIPTION OF THE PREFERRED EMBODIMENTS

Hereinafter, an inference apparatus according to an embodiment will be described with reference to the drawings. In the following embodiment, portions denoted by the same reference numerals perform a similar operation, and redundant description will be appropriately omitted. The following embodiments do not limit the disclosed technology. Each embodiment can be appropriately combined within a range causing no contradiction of processing.

To be more specific, the following will focus on a physical system as a multibody problem in which a substance includes a large number of atomic nuclei and electrons. In the present embodiment, electron transport calculation using the non-equilibrium Green's function may be executed using a Self Consistent Field (SCF) method, and the potential, electron density, and various physical quantities of the substance may be calculated using the result. At this time, the Hamiltonian (potential) as an initial value used for electron transport calculation by the non-equilibrium Green's function may be calculated based on a neural network model trained by machine learning.

Hereinafter, embodiments will be described in detail with reference to the drawings.

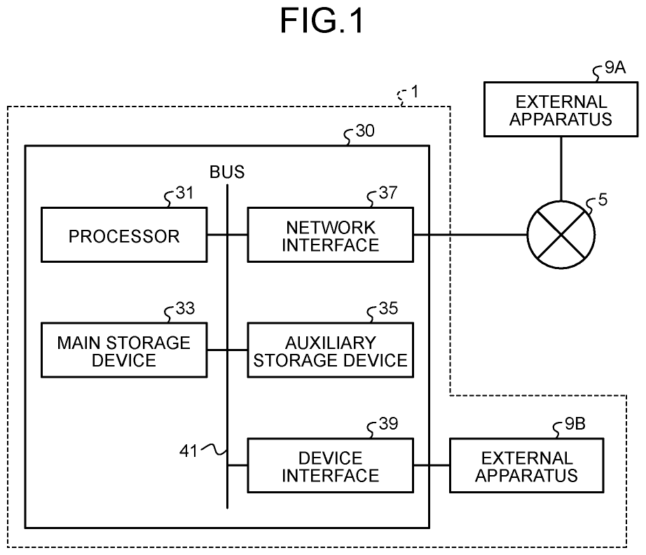

FIG. 1 is a block diagram illustrating an example of a hardware configuration of an inference apparatus 1 according to a first embodiment. As illustrated in FIG. 1, the inference apparatus 1 may be connected to an external apparatus 9A via a communication network 5. Furthermore, the inference apparatus 1 may include an external apparatus 9B connected via a device interface 39.

The inference apparatus 1 may input position information (three-dimensional coordinates) of a plurality of atoms included in a substance and output a Hamiltonian of a three-dimensional molecular structure of the substance. The substance is not limited to a molecule, and may be various crystals or the like.

The inference apparatus 1 may include a computer 30 and the external apparatus 9B connected to the computer 30 via the device interface 39. As an example, the computer 30 may include a processor 31, a main storage device (memory) 33, an auxiliary storage device (memory) 35, a network interface 37, and the device interface 39. The inference apparatus 1 may be implemented as the computer 30 in which the processor 31, the main storage device 33, the auxiliary storage device 35, the network interface 37, and the device interface 39 are connected to each other via a bus 41.

The computer 30 illustrated in FIG. 1 includes one component for each, but may include a plurality of the same components. Although FIG. 1 illustrates one computer 30, software may be installed in a plurality of computers, and each of the plurality of computers may execute the same processing or different partial processing of the software. In this case, the configuration may take a form of distributed computing in which individual computers communicate via the network interface 37 or the like to execute processing. That is, the inference apparatus 1 in the present embodiment may be configured as a system that implements various functions described below by executing instructions stored in one or a plurality of storage devices by one or a plurality of computers. It is also allowable to have a configuration in which information transmitted from a terminal is processed by one or a plurality of computers provided on a cloud, and a result of the processing is transmitted to a terminal such as a display apparatus (display unit) corresponding to the external apparatus 9B.

Various computations of the inference apparatus 1 in the present embodiment may be executed in parallel processing using one or a plurality of processors or using a plurality of computers connected via a network. In addition, various computations may be distributed to a plurality of computation cores in the processor and executed in parallel processing. In addition, some or all of the processing, means, and the like of the present disclosure may be executed by at least one of the processor and the storage device provided on a cloud communicable with the computer 30 via a network. In this manner, various types described below in the present embodiment may be in the form of parallel computing by one or a plurality of computers.

The processor 31 may be an electronic circuit (a process handling circuit, a processing circuit, a processing circuitry, a Central Processing Unit (CPU), a Graphics Processing Unit (GPU), a Field Programmable Gate Array (FPGA), or an Application Specific Integrated Circuit (ASIC), etc.) including a control device and a computation device of the computer 30. Furthermore, the processor 31 may be a semiconductor device or the like including a dedicated process handling circuit. The processor 31 is not limited to an electronic circuit using an electronic logic element, and may be implemented by an optical circuit using an optical logic element. Furthermore, the processor 31 may include a computation function based on quantum computing.

The processor 31 can perform computation processing based on data and software (program) input from each apparatus or the like of the internal configuration of the computer 30 and output a computation result and a control signal to each apparatus or the like. The processor 31 may control each component constituting the computer 30 by executing an operating system (OS), an application, or the like of the computer 30.

The inference apparatus 1 in the present embodiment may be implemented by one or a plurality of processors 31. Here, the processor 31 may refer to one or a plurality of electronic circuits disposed on one chip, or may refer to one or a plurality of electronic circuits disposed on two or more chips or two or more devices. When using a plurality of electronic circuits, the electronic circuits may communicate to each other via a wired or wireless channel.

The main storage device 33 is a storage device that stores instructions executed by the processor 31. Various data, and the like, and information stored in the main storage device 33 is read by the processor 31. The auxiliary storage device 35 is a storage device other than the main storage device 33. These storage devices represent optional electronic components capable of storing electronic information, and may be semiconductor memories. The semiconductor memories may be either a volatile memory or a nonvolatile memory. The storage device for storing various data used in the inference apparatus 3 according to the present embodiment may be implemented by the main storage device 33 or the auxiliary storage device 35, or may be implemented by a built-in memory provided inside the processor 31. For example, the storage unit in the present embodiment may be implemented by the main storage device 33 or the auxiliary storage device 35.

A plurality of processors may be connected (coupled) or a single processor 31 may be connected to one storage device (memory). A plurality of storage devices (memories) may be connected (coupled) to one processor. In a case where the inference apparatus 1 in the present embodiment includes at least one storage device (memory) and a plurality of processors connected (coupled) to the at least one storage device (memory), at least one processor among the plurality of processors may include a configuration in which the at least one processor is connected (coupled) to the at least one storage device (memory). Furthermore, this configuration may be implemented by the storage device (memory) and the processor 31 included in a plurality of computers. Moreover, the storage device (memory) may be integrated with the processor 31 (in the form of a cache memory including L1 cache and L2 cache, for example).

The network interface 37 is an interface for connecting to the communication network 5 by wireless or wired connection. The network interface 37 may use an appropriate interface such as one conforming to an existing communication standard. The network interface 37 may be used to exchange information with the external apparatus 9A connected via the communication network 5. The communication network 5 may be any of a Wide Area Network (WAN), a Local Area Network (LAN), a Personal Area Network (PAN), or the like, or a combination thereof, as long as the network enables communication between the computer 30 and the external apparatus 9A. Examples of the WAN include the Internet, examples of the LAN include IEEE802.11 and Ethernet (registered trademark), and examples of the PAN include Bluetooth (registered trademark) and Near Field Communication (NFC).

The device interface 39 is an interface such as a universal serial bus (USB) directly connected to an output apparatus such as a display apparatus, an input apparatus, and the external apparatus 9B. Note that the output apparatus may include a speaker or the like that outputs sound or the like.

The external apparatus 9A is an apparatus connected to the computer 30 via a network. The external apparatus 9B may be an apparatus directly connected to the computer 30.

As an example, the external apparatus 9A or the external apparatus 9B may be an input apparatus (input unit). The input apparatus is, for example, a device such as a camera, a microphone, motion capture, various sensors, a keyboard, a mouse, or a touch panel, and provides acquired information to the computer 30. Furthermore, the external apparatus 9A or the external apparatus 9B may be a device including an input unit, a memory, and a processor, such as a personal computer, a tablet terminal, or a smartphone.

Furthermore, the external apparatus 9A or the external apparatus 9B may be an output apparatus (output unit) as an example. The output apparatus may be, for example, a display apparatus (display unit) such as a Liquid Crystal Display (LCD), a Cathode Ray Tube (CRT), a Plasma Display Panel (PDP), or an organic Electro Luminescence (EL) panel, or may be a speaker that outputs sound or the like. Furthermore, the external apparatus 9A or the external apparatus 9B may be a device including an output apparatus, a memory, and a processor, such as a personal computer, a tablet terminal, or a smartphone.

Furthermore, the external apparatus 9A or the external apparatus 9B may be a storage device (memory). For example, the external apparatus 9A may be a network storage device or the like, and the external apparatus 9B may be a storage device such as an HDD.

Furthermore, the external apparatus 9A or the external apparatus 9B may be an apparatus having some functions of the components of the inference apparatus 1 in the present embodiment. That is, the computer 30 may transmit or receive a part or all of the processing result of the external apparatus 9A or the external apparatus 9B.

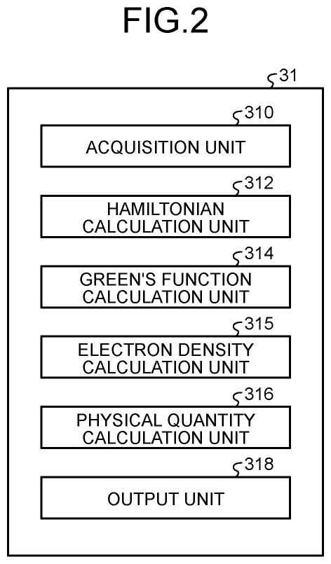

FIG. 2 is a diagram illustrating an example of functional blocks in the processor 31. The processor 31 may include functions to be implemented by the processor 31, such as an acquisition unit 310, a Hamiltonian calculation unit 312, a Green's function calculation unit 314, an electron density calculation unit 315, a physical quantity calculation unit 316, and an output unit 318, for example. The functions implemented by the acquisition unit 310, the Hamiltonian calculation unit 312, the Green's function calculation unit 314, the electron density calculation unit 315, the physical quantity calculation unit 316, and the output unit 318 may be stored as programs in, for example, the main storage device 33, the auxiliary storage device 35, or the like. The processor 31 can implement functions related to the acquisition unit 310, the Hamiltonian calculation unit 312, the Green's function calculation unit 314, the electron density calculation unit 315, the physical quantity calculation unit 316, and the output unit 318 by reading and executing a program stored in the main storage device 33, the auxiliary storage device 35, or the like.

The acquisition unit 310 may acquire position information (three-dimensional coordinates) of each atom as an initial value for a substance to be an object based on an input by a user, for example. Note that the position information of each atom as the initial position may be any three-dimensional coordinates. The present embodiment uses an exemplary case where the processor 31 of the inference apparatus 1 implements the Hamiltonian calculation unit 312. However, in a case where the Hamiltonian calculation unit 312 is provided in another apparatus, the acquisition unit 310 may acquire the Hamiltonian as an initial value calculated in the another apparatus.

The Hamiltonian calculation unit 312 may input the position information of each atom acquired by the acquisition unit 310 and calculate the Hamiltonian as the initial value of the substance from the position information of each atom included in the substance. The Hamiltonian calculation unit 312 is implemented by a trained model, for example. An applicable example of the trained model is a neural network model.

In addition, in a case of sequentially executing electron transport calculation by the non-equilibrium Green's function using the SCF method, the Hamiltonian calculation unit 312 may calculate the potential difference using the difference in the electron density calculated by the electron density calculation unit 315 and using the Poisson's equation and may update the Hamiltonian using the calculated difference. Furthermore, in a case where a difference in electron density between the electron density obtained as latest data (latest electron density) and the electron density obtained as previous data (previous electron density) is a predetermined threshold or less in determination processing (to be described below) in the electron density calculation unit 315, the Hamiltonian calculation unit 312 may estimate the latest Hamiltonian as a Hamiltonian optimized for the substance.

The Green's function calculation unit 314 may calculate the non-equilibrium Green's function using the Hamiltonian as the initial value calculated by the Hamiltonian calculation unit 312 or the updated Hamiltonian and the inverse matrix algorithm. In particular, the Green's function calculation unit 314 may calculate the optimized non-equilibrium Green's function based on the optimized Hamiltonian calculated by the Hamiltonian calculation unit 312.

In the case of sequentially executing the electron transport calculation by the non-equilibrium Green's function using the SCF method, the electron density calculation unit 315 may spatially integrate the latest non-equilibrium Green's function calculated by the Green's function calculation unit 314 to calculate and update the electron density.

In addition, in the case of sequentially executing the electron transport calculation by the non-equilibrium Green's function using the SCF method, the electron density calculation unit 315 may calculate a difference between the latest electron density and the previous electron density. The electron density calculation unit 315 may execute determination processing of determining whether the calculated difference between the electron densities is a predetermined threshold or less.

The physical quantity calculation unit 316 may calculate a predetermined physical quantity based on the optimized non-equilibrium Green's function. Here, the predetermined physical quantity may include at least any of local density of states, transmittance, current, capacitance, charge, and spin distribution of a substance. The method of calculating these physical quantities may be an existing method.

The output unit 318 may output the physical quantity calculated by the physical quantity calculation unit 316 to the main storage device 33 and/or the auxiliary storage device 35. The output unit 318 can also output the physical quantity calculated by the physical quantity calculation unit 316 to the external apparatus 9A via the communication network 5.

### Inference Processing

Next, the inference processing implemented by the inference apparatus 1 according to the embodiment will be described. The present inference processing may include execution of electron transport calculation by a non-equilibrium Green's function and estimation of a predetermined physical quantity of a substance to be an object. At this time, the Hamiltonian calculated by the neural network model may be used as the initial value. Furthermore, the present inference processing may include a case of using the SCF method and a case of not using the SCF method.

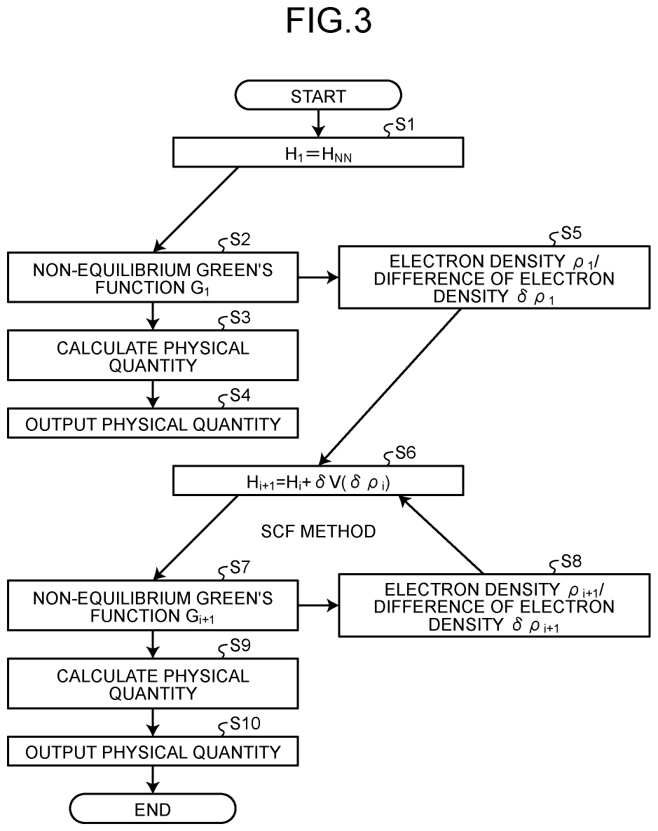

FIG. 3 is a diagram for illustrating a concept of inference processing implemented by the inference apparatus 1 according to the embodiment.

First, inference processing in the case of not using the SCF method will be described. As illustrated in FIG. 3, when the position information of each atom is input, the Hamiltonian calculation unit 312 may calculate a Hamiltonian H₁=H_{NN} as an initial value using a neural network model (step S1).

The Green's function calculation unit 314 may calculate a non-equilibrium Green's function G₁ based on the Hamiltonian H₁=H_{NN} as the initial value (step S2).

The physical quantity calculation unit 316 may calculate a predetermined physical quantity based on the non-equilibrium Green's function G₁ calculated by the Green's function calculation unit 314 (step S3).

The output unit 318 may output the physical quantity calculated by the physical quantity calculation unit 316 (step S4).

The inference processing in the case not using the SCF method does not need the electron density or the sequential calculation. This makes it possible to greatly reduce the calculation load and greatly increase the calculation processing speed.

Next, inference processing of a case using the SCF method will be described. As illustrated in FIG. 3, the electron density calculation unit 315 spatially integrates the non-equilibrium Green's function G₁ calculated by the Green's function calculation unit 314 so as to calculate an electron density ρ₁. In addition, the electron density calculation unit 315 may calculate a difference δρ₁ between a predetermined electron density ρ₀ and the electron density ρ₁ (step S5). Here, the predetermined electron density ρ₀ may be acquired by diagonalizing a Hamiltonian H_{NN}, for example. In addition, the predetermined electron density ρ₀ may be acquired by calculating the Fermi energy and the Hamiltonian H₁ using the same or different neural network models, calculating a non-equilibrium Green's function based on the calculated Hamiltonian H₁, and integrating the calculated non-equilibrium Green's function G₁ from negative infinity up to the Fermi energy. Furthermore, instead of calculating ρ₀, potentials V₀ and H₁ may be calculated as initial values from the position information of each atom using the same or different neural network models, the non-equilibrium Green's function G₁ may be calculated based on the calculated H₁, the electron density ρ₁ may be calculated by spatially integrating the calculated non-equilibrium Green's function G₁, a potential V₁ may be calculated from the calculated electron density ρ₁, δV may be calculated from the calculated potentials V₁ and V₀, and the Hamiltonian may be updated from the calculated δV as described below.

The Hamiltonian calculation unit 312 may calculate a potential difference δV (δρ₁) by using the electron density difference δρ₁ and the Poisson's equation, and may update the Hamiltonian to H₂=H₁ (=H_{NN})+δV (δρ₁) by using the potential difference δV (δρ₁) and the Hamiltonian H₁=H_{NN} as an initial value (step S6: being the case of i=1 in the sequential calculation using the SCF method).

The Green's function calculation unit 314 may calculate a non-equilibrium Green's function G₂ based on H₂=H₁ (=H_{NN})+δV (δρ₁) (step S7).

The electron density calculation unit 315 spatially integrates the non-equilibrium Green's function G₂ calculated by the Green's function calculation unit 314 to calculate an electron density ρ₂. The electron density calculation unit 315 may calculate a difference δρ₂ between the electron density ρ₂ and the previous electron density ρ₁ (step S8).

The Hamiltonian calculation unit 312 may calculate a potential difference δV (δρ₂) by using the electron density difference δρ₂ and the Poisson's equation, and may update the Hamiltonian as H₃=H₂+δV (δρ₂) by using the potential difference δV (δρ₂) and a latest Hamiltonian H₂ (step SS6: being a case where i=>i+1 in the sequential calculation using the SCF method).

Thereafter, sequential calculation of the SCF method may be repeatedly executed until δρ₁ becomes a predetermined threshold or below.

When δρ₁ becomes the predetermined threshold or below, the physical quantity calculation unit 316 may calculate a predetermined physical quantity based on a non-equilibrium Green's function G₁ calculated using a latest Hamiltonian H₁ (step S9).

The output unit 318 may output the physical quantity calculated by the physical quantity calculation unit 316 (step S10).

As described above, the inference apparatus 1 according to the present embodiment may include: the main storage device 33 and the auxiliary storage device 35 as at least one memory; and the processor 31 as at least one processor. The processor 31 may calculate the Hamiltonian H₁=H_{NN} as the initial value regarding the substance based on a neural network algorithm, and may calculate the non-equilibrium Green's function G₁ regarding the substance based on the Hamiltonian H₁=H_{NN} as the initial value.

The processor 31 may calculate the electron density of the substance based on the non-equilibrium Green's function, update the Hamiltonian as an initial value using a potential difference calculated based on the electron density, and update the non-equilibrium Green's function based on the updated Hamiltonian. The processor 31 may update the electron density based on the updated non-equilibrium Green's function, and thereafter repeatedly execute each of the updates until a difference between the latest electron density and the previous electron density becomes a threshold or less. In a case where the difference becomes the threshold or less, the processor 31 may calculate a non-equilibrium Green's function related to the substance based on the latest Hamiltonian.

Therefore, for example, in Hamiltonian calculation as an initial value, there is no need to execute calculation using the DFT method, which needs high load. This makes it possible to greatly reduce a calculation load in calculating a potential (Hamiltonian) of a substance or calculating a non-equilibrium Green's function as compared with the conventional technology. In addition, in the electron transport calculation by the non-equilibrium Green's function using the SCF method, it is empirically known that convergence of the SCF method varies depending on H₁ used as an initial value. In the present embodiment, the highly accurate Hamiltonian H_{NN} obtained based on a neural network algorithm is used as the initial value. This makes it possible improve the convergence of the SCF method, leading to reduction of the number of iterations in sequential calculations. This also can greatly reduce the calculation load, making it possible to handle a larger physical system than before by enlarging the calculation system.

In addition, for example, in the case of using a semi-empirical method in calculation of the Hamiltonian as an initial value, it is known that, when there is a defect or disturbance in the physical system, for example, the Hamiltonian cannot be correctly expressed, even though the calculation load is not high. With the inference apparatus according to the present embodiment, the calculation accuracy can be greatly improved with an equivalent calculation load as compared with the case of using a semi-empirical model.

As described above, it is possible to provide a new method having a relatively low calculation load and high calculation accuracy in substance structure optimization processing.

### First Modification

The physical system as an object of the inference apparatus according to the embodiment can handle, for example, a substance used in a transistor (FET, two-dimensional material), memories (NAND, ReRAM, PCM, DRAM, and MRAM), graphene, a nanoribbon, a nanotube, a cascade laser, a battery, a solar cell, an ion cell, or the like, as an object.

### Second Modification

In the above embodiment, the Hamiltonian H_{NN} calculated based on the neural network algorithm is set as an initial value, and the Hamiltonian is updated by the SCF method so as to execute the electron transport calculation by the non-equilibrium Green's function. Alternatively, an electron density ρ_{NN} corresponding to the Hamiltonian H_{NN} On a one-to-one basis may be acquired by a neural network algorithm, and the Hamiltonian may be updated by the SCF method using the electron density ρ_{NN} as an initial value so as to execute the electron transport calculation by the non-equilibrium Green's function.

Typically, the calculation load in the processing of calculating the Hamiltonian from the electron density is lower than the calculation load in the processing of calculating the electron density from the Hamiltonian. This makes it possible to further reduce the calculation load in the inference processing.

In the case of implementing the technical idea in the embodiment, the Hamiltonian as the initial value regarding the substance may be calculated based on a neural network algorithm, and the non-equilibrium Green's function regarding the substance may be calculated based on the Hamiltonian as the initial value.

In a case of implementing the technical idea in the embodiment by a determination program, the determination program may cause a computer to calculate a Hamiltonian as an initial value regarding a substance based on a neural network algorithm, and calculate a non-equilibrium Green's function regarding the substance based on the Hamiltonian as the initial value.

For example, the inference processing according to the embodiment can also be implemented by installing the determination program in a computer in various analysis devices, analysis servers, or the like configured to analyze a non-equilibrium Green's function or the like of an atomic structure including a plurality of atoms and developing the determination program on a memory. At this time, the program that can cause the computer to execute the method can be distributed by being stored in a storage medium such as a magnetic disk (hard disk or the like), an optical disk (CD-ROM, DVD, etc.), or a semiconductor memory. Since the procedure and effect of the optimum parameter determination processing by the determination program are similar to those of the embodiment, the description thereof will be omitted.

A part or all of the respective devices in any of the above-described embodiments may be configured by hardware, or may be configured by information processing of software (program) executed by a central processing unit (CPU), a graphics processing unit (GPU), or the like. When configured by information processing by software, the information processing of software may be executed by storing software that implements at least part of the functions of the respective devices of any of the above-described embodiments in a non-transitory storage medium (non-transitory computer readable medium) such as a flexible disk, a compact disc-read only memory (CD-ROM), and a universal serial bus (USB) memory and causing the computer 3 to read the software. Furthermore, the software may be downloaded via the communication network 5. Moreover, the information processing may be executed by hardware by the software being implemented in circuitry such as an application specific integrated circuit (ASIC) or a field programmable gate array (FPGA).

The type of a storage medium that stores the software is not limited to a particular type. The storage medium is not limited to a removable storage medium such as a magnetic disk and an optical disk, and may be a stationary storage medium such as a hard disk or a memory. Furthermore, the storage medium may be provided inside the computer or outside the computer.

In the present specification (including claims), an expression “at least one of a, b, and c” or “at least one of a, b, or c” (including similar expressions) includes any of a, b, c, a-b, a-c, b-c, and a-b-c. Furthermore, a plurality of instances may be included for any element, such as a-a, a-b-b, and a-a-b-b-c-c. Moreover, an element other than listed elements (a, b, and c), such as d of a-b-c-d, may be added.

In the present specification (including claims), expressions such as “data as input/based on data/in accordance with/in response to” (including similar expressions) include a case where various pieces of data are used as input and a case where various pieces of data subjected to some kind of processing (e.g., noise added data, normalized data, and intermediate expressions of various pieces of data) are used as input, unless otherwise specified. Furthermore, when it is described that some kind of result is obtained “based on/in accordance with/in response to data”, a case where the result is obtained based only on the data is included, and a case where the result is obtained under the influence of other data, factors, conditions, and/or states other than the data may be also included. Furthermore, when it is described that “data is output”, a case where various pieces of data are used as output and a case where various pieces of data subjected to some kind of processing (e.g., noise added data, normalized data, and intermediate expressions of various pieces of data) are used as output are included, unless otherwise specified.

In the present specification (including claims), the terms “connected” and “coupled” are intended as non-limiting terms including all of direct connection/coupling, indirect connection/coupling, electrical connection/coupling, communicative connection/coupling, operative connection/coupling, physical connection/coupling, and the like. The terms should be appropriately interpreted in accordance with the context in which the terms are used. Connection/coupling forms which are not intentionally or naturally excluded should be interpreted in a non-limiting manner as being included in the terms.

In the present specification (including claims), an expression “A configured to B” may include that the physical structure of the element A has a configuration capable of executing the operation B, and that a permanent or temporary setting/configuration of the element A is configured/set to actually execute the operation B. For example, when the element A is a general-purpose processor, the processor may have a hardware configuration capable of executing the operation B, and the processor is only required to be configured to actually execute the operation B by permanent or temporary program (command) setting. Furthermore, when the element A is a dedicated processor, dedicated arithmetic circuitry, and the like, the circuitry structure of the processor is only required to be implemented to actually execute the operation B regardless of whether or not a control command and data are actually attached.

In the present specification (including claims), terms meaning inclusion or possession (e.g., “comprising/including” and “having”) are intended as open-ended terms including a case where objects other than targets indicated by objects of the terms are included or possessed. When an object of a term meaning inclusion or possession is an expression that does not designate number and quantity or an expression that suggests a singular number (expression with article “a” or “an”), the expression should be interpreted as not being limited to a specific number.

In the present specification (including claims), even if an expression such as “one or more” or “at least one” is used in one part and an expression that does not designate number and quantity or an expression that suggests a singular number (expression with article “a” or “an”) is used in another part, the latter expression is not intended to mean “one”. In general, the expression that does not designate number and quantity or the expression that suggests a singular number (expression with article “a” or “an”) should be interpreted as not necessarily being limited to a specific number.

In the present specification, when it is described that a specific effect (advantage/result) is obtained in a specific configuration of a certain embodiment, it should be understood that the effect is obtained in one or a plurality of other embodiments having the configuration unless there is some special reason. Note, however, that it should be understood that the presence or absence of the effect generally depends on various factors, conditions, and/or states, and that the effect is not necessarily obtained by the configuration. The effect is merely obtained by the configuration described in an embodiment when various factors, conditions, and/or states are satisfied. The effect is not necessarily obtained in the invention according to claims in which the configuration or a similar configuration is specified.

In the present specification (including claims), terms such as “maximize” include determining a global maximum, determining an approximation of the global maximum, determining a local maximum, and determining an approximation of the local maximum, and should be appropriately interpreted depending on the context in which the terms are used. Furthermore, stochastically or heuristically determining an approximation of the maximum is included. Similarly, terms such as “minimize” include determining a global minimum, determining an approximation of the global minimum, determining a local minimum, and determining an approximation of the local minimum, and should be appropriately interpreted depending on the context in which the terms are used. Furthermore, stochastically or heuristically determining an approximation of the minimum is included. Similarly, terms such as “optimize” include determining a global optimum, determining an approximation of the global optimum, determining a local optimum, and determining an approximation of the local optimum, and should be appropriately interpreted depending on the context in which the terms are used. Furthermore, stochastically or heuristically determining an approximation of the optimum is included.

In the present specification (including claims), to perform certain processing by multiple pieces of hardware, the pieces of hardware may perform the processing in cooperation or part of the hardware may perform the entire processing. Alternatively, part of the hardware may perform part of the processing while another part of the hardware may perform the rest of the processing. In the present specification (including claims), an expression such as “one or more pieces of hardware perform first processing and the one or more pieces of hardware perform second processing”, if used, may signify that the hardware that performs first processing and the hardware that performs second processing may be the same or different from each other. In other words, the hardware that performs first processing and the hardware that performs second processing may only be included in the one or more pieces of hardware. Such hardware may include electronic circuitry or a device including electronic circuitry.

In the present specification (including claims), when multiple storages (memory) store data, the individual storages may store only part of the data or the data as a whole.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An inference apparatus comprising:
at least one memory; and
at least one processor,
wherein the at least one processor
calculates a Hamiltonian regarding a substance by a neural network, and
calculates a non-equilibrium Green's function regarding the substance based on the Hamiltonian.

2. The inference apparatus according to claim 1,
wherein the at least one processor
calculates a predetermined physical quantity of the substance based on the non-equilibrium Green's function.

3. The inference apparatus according to claim 1,
wherein the at least one processor
calculates an electron density based on the non-equilibrium Green's function,
updates the Hamiltonian using a potential difference calculated based on the electron density,
updates the non-equilibrium Green's function based on the updated Hamiltonian,
updates the electron density based on the updated non-equilibrium Green's function, and
repeatedly executes each of the updates until a difference between the electron density obtained as latest data and the electron density obtained as previous data becomes a threshold or less, and when the difference becomes the threshold or less, calculates the non-equilibrium Green's function for the substance based on the Hamiltonian obtained as latest data.

4. The inference apparatus according to claim 3,
wherein the at least one processor
calculates a predetermined physical quantity of the substance based on the non-equilibrium Green's function obtained as latest data.

5. The inference apparatus according to claim 1,
wherein the at least one processor
inputs position information of each atom of the substance into the neural network,
wherein the Hamiltonian is calculated from the position information by the neural network.

6. The inference apparatus according to claim 4,
wherein the predetermined physical quantity includes at least any of local density of states, transmittance, current, capacitance, charge, and spin distribution of the substance.

7. The inference apparatus according to claim 3,
wherein an initial value of the electron density is calculated by diagonalizing the Hamiltonian, integrating the non-equilibrium Green's function up to Fermi energy, or using a neural network which is same as or different from the neural network.

8. An inference apparatus comprising:
at least one memory; and
at least one processor,
wherein the at least one processor
calculates an electron density regarding a substance by a neural network,
calculates a Hamiltonian regarding the substance based on the electron density, and
calculates a non-equilibrium Green's function regarding the substance based on the Hamiltonian.

9. The inference apparatus according to claim 8,
wherein the at least one processor
calculates a predetermined physical quantity of the substance based on the non-equilibrium Green's function.

10. The inference apparatus according to claim 8,
wherein the at least one processor
updates the electron density based on the non-equilibrium Green's function,
updates the Hamiltonian using a potential difference calculated based on the electron density,
updates the non-equilibrium Green's function based on the updated Hamiltonian,
updates the electron density based on the updated non-equilibrium Green's function, and
repeatedly executes each of the updates until a difference between the electron density obtained as latest data and the electron density obtained as previous data becomes a threshold or less, and when the difference becomes the threshold or less, calculates the non-equilibrium Green's function for the substance based on the Hamiltonian obtained as latest data.

11. The inference apparatus according to claim 10,
wherein the at least one processor
calculates a predetermined physical quantity of the substance based on the non-equilibrium Green's function obtained as latest data.

12. An inference method comprising:
calculating, by one or more processor, a Hamiltonian regarding a substance by a neural network, and
calculating, by the one or more processor, a non-equilibrium Green's function regarding the substance based on the Hamiltonian.

13. The inference method according to claim 12, further comprising:
calculating, by the one or more processor, a predetermined physical quantity of the substance based on the non-equilibrium Green's function.

14. The inference method according to claim 12, further comprising:
calculating, by the one or more processor, an electron density based on the non-equilibrium Green's function,
updating, by the one or more processor, the Hamiltonian using a potential difference calculated based on the electron density,
updating, by the one or more processor, the non-equilibrium Green's function based on the updated Hamiltonian,
updating, by the one or more processor, the electron density based on the updated non-equilibrium Green's function, and
repeatedly executing, by the one or more processor, each of the updating until a difference between the electron density obtained as previous data becomes a threshold or less, and when the difference becomes the threshold or less, calculating, by the one or more processor, the non-equilibrium Green's function for the substance based on the Hamiltonian obtained as latest data.

15. The inference method according to claim 14, further comprising:
calculating, by the one or more processor, a predetermined physical quantity of the substance based on the non-equilibrium Green's function.

16. The inference method according to claim 13,
wherein the predetermined physical quantity includes at least any of local density of states, transmittance, current, capacitance, charge, and spin distribution of the substance.

17. The inference method according to claim 15,
wherein the predetermined physical quantity includes at least any of local density of states, transmittance, current, capacitance, charge, and spin distribution of the substance.

18. The inference method according to claim 14,
wherein an initial value of the electron density is calculated by diagonalizing the Hamiltonian, integrating the non-equilibrium Green's function up to Fermi energy, or using a neural network which is same as or different from the neural network.

19. An inference method comprising:
calculating, by one or more processor, an electron density regarding a substance by a neural network,
calculating, by the one or more processor, a Hamiltonian regarding a substance based on the electron density, and
calculating, by the one or more processor, a non-equilibrium Green's function regarding the substance based on the Hamiltonian.

20. The inference method according to claim 19, further comprising:
updating, by the one or more processor, the electron density based on the non-equilibrium Green's function,
updating, by the one or more processor, the Hamiltonian using a potential difference calculated based on the electron density,
updating, by the one or more processor, the non-equilibrium Green's function based on the updated Hamiltonian,
updating, by the one or more processor, the electron density based on the updated non-equilibrium Green's function, and
repeatedly executing each of the updating until a difference between the electron density obtained as latest data and the electron density obtained as previous data becomes a threshold or less, and when the difference becomes the threshold or less, calculating the non-equilibrium Green's function for the substance based on the Hamiltonian obtained as latest data.
